(19) United States
(12) Patent Application Publication
(10) Pub. No.: US 2013/0052490 A1
(43) Pub. Date: Feb. 28, 2013

(54) ENVIRONMENTAL CONTROL USING A DYNAMIC TEMPERATURE SET POINT

(71) Applicants: Broc William TenHouten, Santa Monica, CA (US); Philippe Hart Gow, Santa Monica, CA (US)

(72) Inventors: Broc William TenHouten, Santa Monica, CA (US); Philippe Hart Gow, Santa Monica, CA (US)

(73) Assignee: Coda Automotive, Inc., Los Angeles, CA (US)

(21) Appl. No.: 13/216,000

(22) Filed: Aug. 23, 2011

(51) Int. Cl. H01M 10/50

(52) U.S. Cl. 429/50; 429/120; 429/62

(57) ABSTRACT

Systems and methods related to controlling the environment within a cabin-external battery pack of a vehicle are generally described. In some embodiments, the cabin and the battery have independent cooling and/or heating loops. The inventors have found that effective environment control can be achieved by controlling the cooling system dynamically, that is, determining a suitable cooling element (e.g., evaporator) operating temperature based on a multitude of vehicle operating parameters without implementing a fixed set point, and then cooling and/or heating the battery pack accordingly. In some embodiments, the battery pack temperature control system includes a controller configured to determine a condition related to the operating state of the vehicle (e.g., by receiving a signal corresponding to the condition) and alter a temperature set point in the control system based at least in part upon the condition. In this way, the cooling load provided to the battery pack can be adjusted depending upon a variety of factors related to the operating state of the vehicle.

### FIELD

Systems and methods related to controlling a battery pack environment within a vehicle are generally described. In some embodiments, the battery pack environment control is achieved using a temperature set point that varies in response to at least one condition of the vehicle.

### BACKGROUND

Battery packs within electric vehicles (EVs) can exhibit reduced performance when they are operated outside a predetermined range of temperatures. For example, when some battery cells within the pack are too hot, undesirable chemical reactions can occur and/or components of a battery cell and/or battery pack can be compromised. In some cases, when the temperature within a battery pack is too cold, power output can be diminished and, at sufficiently low temperatures, battery cells will not charge or discharge effectively. Moreover, thermal gradients within a battery pack (within a battery cell and/or from one battery cell to another) can lead to unpredictable power output, among other adverse effects. For these reasons, among others, the ability to control the temperature of vehicle battery packs is desirable.

In previous battery pack temperature control systems, the temperature is controlled to a fixed evaporator set point. The temperature is often set at or just above 0° C. in order to prevent ice buildup. The use of fixed evaporator temperature set points, however, can be disadvantageous for a variety of reasons. Accordingly, improved systems and methods are desirable.

### SUMMARY

Battery pack environment control using variable temperature set points is generally described.

In one aspect, a system for controlling temperature within a battery pack of a vehicle is described. In some embodiments, the system comprises a battery pack and a control unit constructed and arranged to alter a temperature set point of a cooling element configured to alter a temperature of the battery pack. In some embodiments, the alteration of the temperature set point of the cooling element is based at least in part upon a condition related to an operating state of the vehicle.

In another aspect, a method of controlling temperature within a battery pack of a vehicle is described. In some embodiments, the method comprises determining a condition related to an operating state of the vehicle and, based at least in part upon the determination, altering a temperature set point of a cooling element configured to alter a temperature of the battery pack. In some embodiments, the method further comprises altering a temperature of the battery pack in response to the alteration of the temperature set point.

Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a flow diagram of a temperature control system, according to one set of embodiments;

FIG. 2 is, according to some embodiments, a schematic diagram of a battery pack temperature control system;

FIGS. 3A-3B are schematic diagrams illustrating heating and cooling conduit loops for a battery pack and a cabin of a vehicle, according to one set of embodiments;

FIG. 4 is a schematic diagram illustrating, according to one set of embodiments, a heat integration system of a vehicle; and

FIG. 5 is an exemplary plot of temperature as a function of time, comparing a system in which standard thermal management is employed to a system in which proactive thermal management is employed, according to one set of embodiments.

### DETAILED DESCRIPTION

Systems and methods related to controlling the environment within a cabin-external battery pack of a vehicle are generally described. In some embodiments, the cabin and the battery have independent cooling and/or heating loops. The inventors have found that effective environment control can be achieved by controlling the cooling system dynamically, that is, determining a suitable cooling element (e.g., evaporator) operating temperature based on a multitude of vehicle operating parameters without implementing a fixed set point, and then cooling and/or heating the battery pack accordingly.

The battery pack temperature control system can include a controller configured to determine a condition related to the operating state of the vehicle (e.g., by receiving a signal corresponding to the condition) and alter a temperature set point of a cooling element (e.g., evaporator) in the control system based at least in part upon the condition. Altering the temperature set point of the cooling element can change the temperature of the temperature control fluid that is transported to the battery pack. For example, in one embodiment, the controller determines a condition related to an operating state of the vehicle and, in response, alters the temperature set point of a cooling element (e.g., an evaporator) used to cool a temperature control fluid configured to alter the temperature of the battery pack (e.g., by being fluidically and thermally connected to the battery pack). After the temperature set point of the cooling element has been altered, the temperature control fluid transported across the cooling element and to the battery pack can be cooled to a greater or lesser degree, relative to the degree the fluid was cooled prior to adjustment of the temperature set point. In this way, the cooling load provided to the battery pack can be adjusted depending upon a variety of factors related to the operating state of the vehicle. Such embodiments can be used, for example, to gradually cool a battery pack by initially setting the temperature of the cooling element to be relatively close to the temperature of the battery pack and subsequently lowering the temperature set point of the cooling element over time.

A variety of conditions related to the operating state of the vehicle can be used by the control system to adjust the temperature set point of the cooling element (e.g., evaporator). In some embodiments, the controller is constructed and arranged to alter the temperature set point of the cooling element based upon a plurality of signals, such as one or more signals indicative of the substantially instantaneous and/or average acceleration level, the substantially instantaneous and/or average deceleration level, the substantially instantaneous and/or average speed of the vehicle, a regenerative braking level, the state of charge of the battery pack, the rate of change of the state of charge of the battery pack, a characteristic of a programmable driver profile, one or more temperatures, a ratio of fresh temperature control fluid (e.g., air) to recirculated temperature control fluid (e.g., air) being used to cool the battery pack, and/or the anticipated route (including, for example, anticipated road grades) the vehicle will travel (e.g., as programmed into a vehicle navigation system).

The ability to adjust the temperature set point of the cooling element (e.g., evaporator) based upon a vehicle condition can provide a variety of advantages. For example, the ability to vary the temperature of the temperature control fluid (e.g., a gas such as air) exiting the cooling element (and subsequently entering the battery pack) can allow one to gradually vary the temperature at which a temperature control fluid is provided to the battery pack. Gradually varying the temperature of the fluid (e.g., air) entering the battery pack can reduce thermal shock (i.e., large changes in temperature which can happen when, for example, a relatively warm battery pack is exposed to relatively cold temperature control fluid). In addition, cooling of the battery pack can be controlled such that thermal gradients between different zones of the battery pack are reduced. The reduction of thermal gradients and thermal shock within the battery pack can enhance battery pack performance.

Using a variable set point of the cooling element (e.g., evaporator) also allows one to decouple the blower speed from the temperature of the temperature control fluid delivered to the battery pack by giving more control over the instantaneous evaporator temperature. For example, to cool a temperature control fluid to a given temperature, one might choose a relatively low blower speed and a relatively high cooling element temperature set point or a relatively high blower speed and a relatively low cooling element temperature set point.

In addition, dynamic control of the cooling element temperature set point also allows the vehicle designer to run the compressor and/or fan more continuously, turning these components on and off less often. For example, when fixed cooling element temperature set points are employed, the cooling element must be turned off once the desired battery temperature has been reached in order to avoid over-cooling the battery pack. When variable cooling element temperature set points are employed, on the other hand, one can continue to run the cooling element at, for example, a relatively high temperature set point to avoid over-cooling of the battery pack.

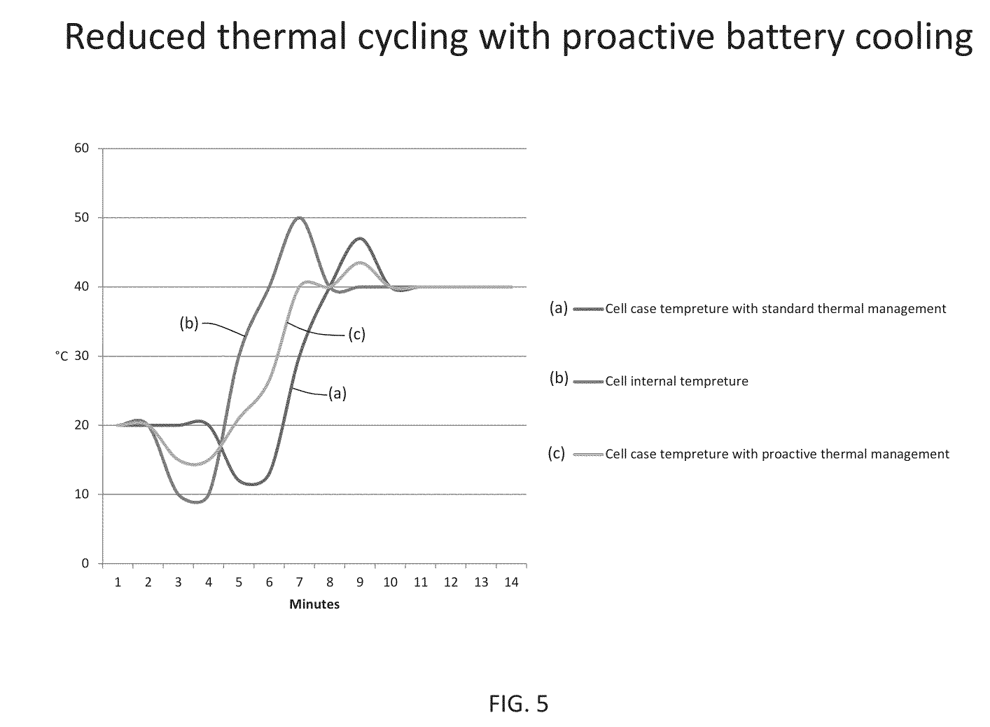

The ability to dynamically vary the temperature set point at the cooling element (e.g., evaporator) also provides the ability to more effectively estimate the instantaneous heating and adjust the battery cooling accordingly. The ability to proactively avoid heating of the cells is further facilitated by the nature of cell heating. Typically, the majority of the heat generated within the battery is produced inside the individual cells. There is a transient heat transfer time for the heat of the cells to propagate outward, which allows additional time for the thermal management system to heat the cell cases in advance of the impending temperature rise propagating outward from the inside of the cell. By evaluating the various factors which effect the heat generation and rejection within the pack, a function can be defined to predict the heat generation characteristics of a given pack based on the instantaneous and historical thermal factors. The result of this function can be used to determine what the cooling requirements will be in the near future as the heat propagates from inside the cells to the cell cases, potentially reducing thermal spikes and thermal cycling by adjusting cooling or heating requirements ahead of temperature rises outside of the cell cases. An example of a reduction in thermal cycling is depicted in FIG. 5. This principle can be extended to account for heat generation characteristics that will be encountered in the future, for example, by accounting for cooling requirements anticipated during a planned route (e.g., a route that is programmed into the vehicle's navigation system), such as anticipated road conditions, traffic, and/or weather conditions anticipated by the vehicle telematics system, and the like.

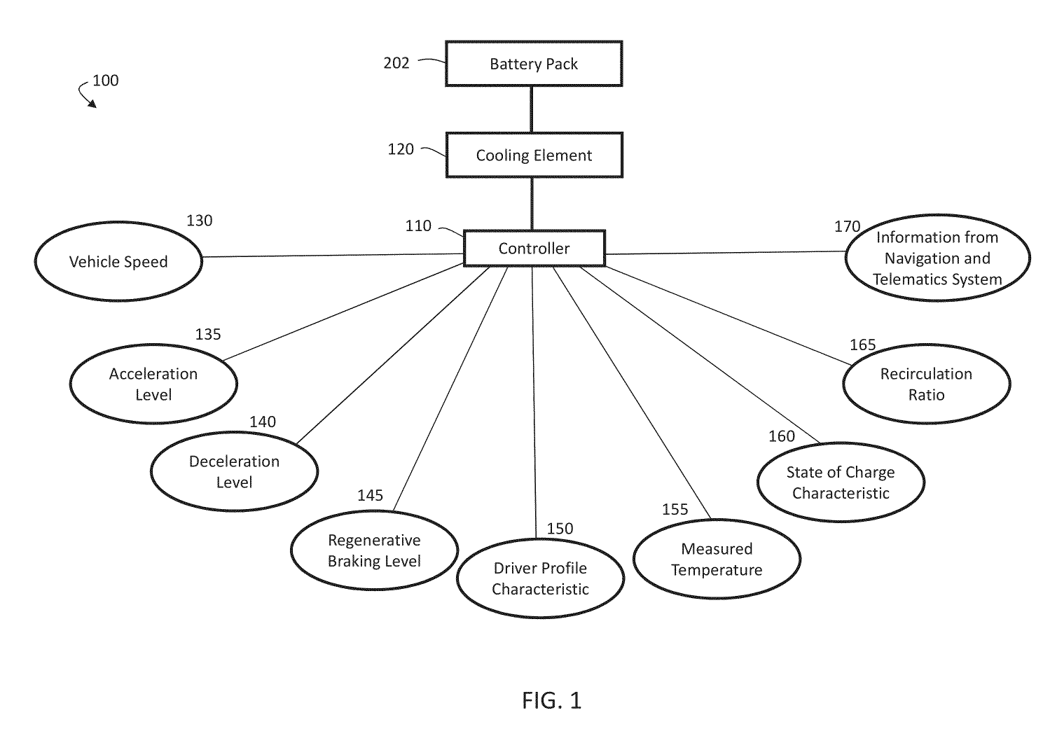

FIG. 1 includes a schematic flow diagram outlining the operation of a temperature control system 100 for controlling the temperature of a battery pack 202 of a vehicle. As used herein, a “battery pack” can include a plurality of battery cells or a single battery cell. Controller 110 can be constructed and arranged to receive a signal indicative of an operating condition of the vehicle. In response to the signal(s) received by the controller, the controller can adjust a temperature set point of cooling element 120 (e.g., an evaporator) in the temperature control system. It should be appreciated that, although the cooling element is an evaporator in one embodiment, the present invention is not limited in this regard, as other suitable cooling system components, or indeed other suitable environmental control devices may be employed.

In temperature control system 100, the signal upon which the temperature set point is altered can be indicative of a variety of operating conditions of the vehicle. For example, in some embodiments, the signal upon which the temperature set point of the cooling element is altered can be indicative of a speed of the vehicle 130. The speed of the vehicle can be a substantially instantaneous speed and/or an average speed. For example, in one embodiment, the substantially instantaneous speed of a vehicle can be determined (e.g., using a microprocessor and associated logic), which can then be used to alter the temperature set point of the cooling element in the battery pack temperature control system. In another embodiment, the average speed of the vehicle can be determined over a set period of time, which can then be used to alter the temperature set point of the cooling element in the battery pack temperature control system.

As a specific example, in some embodiments, suitable sensor(s) detect a relatively high rate of vehicle speed, indicating that a relatively high rate of current draw from the battery, generating more heat that will need to be rejected. In response, the cooling element (e.g., evaporator) temperature set point can be adjusted lower to compensate for the additional temperature increase. In some embodiments, the temperature set point of the cooling element can be adjusted lower prior to significant temperature increases within the battery pack. By proactively adjusting the cooling load to reject additional heat ahead of temperature increases, thermal cycling of the battery pack may be reduced. The reduction in thermal cycling generally will help extend battery life.

As another example, if the sensor(s) detect a relatively low rate of speed, low acceleration rate, low deceleration rate, or a relatively high ambient temperature, then the battery thermal management system may set the temperature set point of the cooling element to a moderate temperature (e.g., 30° C.) and/or select a lower blower fan speed. This selection of control parameters will, in certain embodiments, help minimize noticeable start-up and/or shut down noises as well as reduce blower noise, while continuing to allow the cooling load to be matched to the system's heat generation at that time. The temperature set point of the cooling element may be lowered, for example, if the ambient temperature were to rise (e.g., at some time later in the day), if the vehicle were to ascend a large mountain pass, etc. Generally, when the temperature control fluid is transported at lower flow rates, the temperature control fluid should be cooled to a greater extent relative to high flow rate situations to reach the same battery pack target temperature over a set period of time, all other factors being equal. By accounting for blower speed when determining the compressor output to reach the desired instantaneous evaporator set point, the battery thermal system will exhibit less undesired oscillation and less switching on and off than would be indicative of a more traditional system.

In some embodiments, the signal upon which the temperature set point of the cooling element (e.g., evaporator) is altered can be indicative of an acceleration level 135 and/or a deceleration level 140. The acceleration level and/or deceleration level can be a substantially instantaneous level. For example, the acceleration level and/or deceleration level can be determined (e.g., using a sensor, a microprocessor and associated logic) at a set point in time, and the instantaneous level can be used to set the temperature set point of the cooling element. In other cases, the acceleration and/or deceleration level can be measured over a period of time, and an average acceleration and/or deceleration level can be determined. This average level can then be used to alter the temperature set point of the cooling element.

As a specific example, relatively rapid acceleration can be determined in some embodiments. In anticipation of the relatively high rate of current draw from the battery required to achieve the rapid acceleration, the temperature set point of the cooling element within the battery pack temperature control system can be set to a relatively low temperature. In some instances, light deceleration may be determined. In some such cases, in anticipation of the relatively low rate of current draw from the battery required during the light deceleration, the cooling element within the battery pack temperature control can be set to a relatively high temperature.

In some embodiments, the vehicle may be configured with a regenerative braking system, and the signal upon which the temperature set point is altered can be indicative of a regenerative braking level 145. Generally, a regenerative braking system can be activated when a user applies the brakes of a vehicle and/or when the user decreases the throttle (e.g., “coasts”). Operation of the regenerative braking system may recover kinetic energy from the operation of the vehicle for use in charging the battery pack of the vehicle. Regenerative braking can cause heating of the battery pack as it is recharged. Accordingly, it can be advantageous to adjust the temperature set point of the battery pack cooling element to compensate for the generated heat. As a specific example, in some embodiments, the regenerative braking level can be relatively high, during which the battery can be recharged at a relatively high rate. In some such embodiments, controller 110 can set the temperature of cooling element 120 to a relatively low temperature to compensate for the excess heat generated during a period of relatively high regenerative braking.

In some embodiments, a signal indicative of at least one characteristic of a driver profile 150 can be used by the controller to alter the temperature set point of the cooling element in the temperature control system. For example, the vehicle may be equipped with memory capable of storing a driver profile including one or more characteristics of the driver's behavior. The driver profile can be preprogrammed and stored within the memory in some embodiments. In other cases, the driver profile (and optionally, the memory) can be updated as the vehicle is used, for example, using logic within the vehicle (which can include logic within the control system). In some embodiments, the driver profile can be both preprogrammed and updated as the vehicle is used.

In one specific set of embodiments, a driver profile may be activated that includes relatively aggressive driving characteristics (e.g., relatively high acceleration, speed, etc.). In some such embodiments, controller 110 can receive a signal indicative of the relatively aggressive profile and set the temperature set point of cooling element 120 to a relatively low temperature, in anticipation of the relatively high cooling load that may be required during operation under the aggressive profile. For example, if the driver profile indicates that the driver tends to operate the vehicle at fast speeds and/or high acceleration levels, the temperature set point of cooling element 120 may be set at a relatively low temperature in anticipation of the relatively high current draw from the battery pack. On the other hand, if the driver profile indicates that the driver tends to operate the vehicle at slow speeds and/or low acceleration levels, the temperature set point of cooling element 120 may be set at a relatively low temperature in anticipation of the relatively low current draw from the battery pack. As another example, if the driver profile indicates that the driver frequently uses the brake, the temperature set point of cooling element 120 may be set to a relatively low temperature in anticipation of the relatively high amount of battery pack recharging associated with regenerative braking. In some embodiments, the temperature set point of cooling element 120 in the temperature control system 100 can be altered by controller 110 in response to a signal indicative of a measured temperature 155. In some embodiments, the measured temperature can be indicative of an environment outside the battery pack and/or outside the vehicle. For example, the temperature set point of the cooling element within the temperature control system can be altered by the controller, in some cases, in response to a temperature indicative of the ambient air outside the vehicle. As a specific example, one or more temperature sensors can be arranged within an air intake manifold, and a temperature of the incoming air can be measured. The temperature set point of the cooling element can be altered based, at least in part, on the temperature of the incoming air. If the air temperature is too high, the temperature set point of the cooling element might be set at a relatively low temperature. If the air temperature is sufficiently low, the temperature set point of the cooling element can be set at a relatively high temperature.

In some embodiments, the temperature set point of the cooling element within the temperature control system can be altered by the controller in response to a temperature measured within the battery pack (e.g., a single temperature and/or multiple temperatures, which may be indicative of a temperature gradient within the pack). For example, temperature sensors can be arranged within one and/or more regions of the battery pack, and, if a temperature is determined to be too high, the temperature set point of the temperature control system can be set to a relatively low value, thereby more effectively cooling the heated point within the battery pack.

In some embodiments, the temperature set point of cooling element 120 in the temperature control system 100 can be altered by controller 110 in response to a signal indicative of a characteristic of the state of charge 160 of the battery pack. For example, in some embodiments, a signal indicative of a relatively low state of charge can be transmitted to controller 110. In response to the low state of charge, the controller can set the temperature of cooling element 120 to a relatively low temperature, which can more effectively dissipate heat generated while charging the battery pack (e.g., by activating a cooling fan to pass a temperature control fluid such as air over the relatively cold cooling element during charging). As another example, a signal indicative of a relatively high rate of change in the state of charge (e.g., a high rate of charge and/or a high rate of discharge) of the battery pack can be transmitted to controller 110. In response to the high rate of change, the controller can set the temperature of cooling element 120 to a relatively low temperature, which can more effectively dissipate heat generated during fast charging and/or discharging.

The temperature set point of cooling element 120 in the temperature control system 100 can be altered by controller 110, in some embodiments, in response to a signal indicative of a ratio of fresh temperature control fluid (e.g., air) to battery-pack recirculated components of the temperature control fluid (e.g., air) within the battery pack (i.e., recirculation ratio 165 in FIG. 1). As one example, when recirculated air has already been cooled via the cooling element (e.g., evaporator), it is dryer than fresh air being introduced into the system (e.g., via the battery HVAC box). As the proportion of fresh air is increased, the composite humidity of the air will increase, which will have a higher thermal capacity than the dryer air, which can be accounted for in the cooling calculation.

In some embodiments, the temperature set point of cooling element 120 can be altered by controller 110 in response to information from the navigation and telematics system 170. The navigation and telematics system may store or be programmed to include information related to, for example, the anticipated length of an upcoming trip, the anticipated average speed of travel, the anticipated grade of the road, the anticipated amount of traffic, and/or anticipated weather conditions, any of which may be useful in determining and setting an appropriate temperature set point for the cooling element. As one example, a relatively long trip may be programmed into the navigation and telematics system, in which case, the temperature set point of the cooling element may be set to a relatively low value in anticipation of the relatively large amount of current that will be drawn from the battery pack (and, therefore, a relatively large amount of heat that will be generated by the battery pack) during the trip. As another example, the route chosen by or programmed into the navigation and telematics system may include one or more roads with a relatively steep grade, in which case the temperature set point of the cooling element may be set to a relatively low value in anticipation of the relatively large amount of current that will need to be drawn from the battery pack to climb the grade. In some embodiments, the navigation and telematics system may anticipate a relatively fast average speed for an upcoming trip, in response to which the temperature set point of the cooling element may be set to a relatively low value. The navigation and telematics system may, in some cases, anticipate that a relatively large amount of traffic, in which case, the temperature set point of the cooling element may be set to a relatively high value in anticipation of the low amount of energy needed from the battery during slowed or stopped movement of the vehicle. In yet another example, the navigation and telematics system may anticipate that the upcoming route includes relatively cool and/or rainy weather, in which case the temperature set point of the cooling element may be set to a relatively low value.

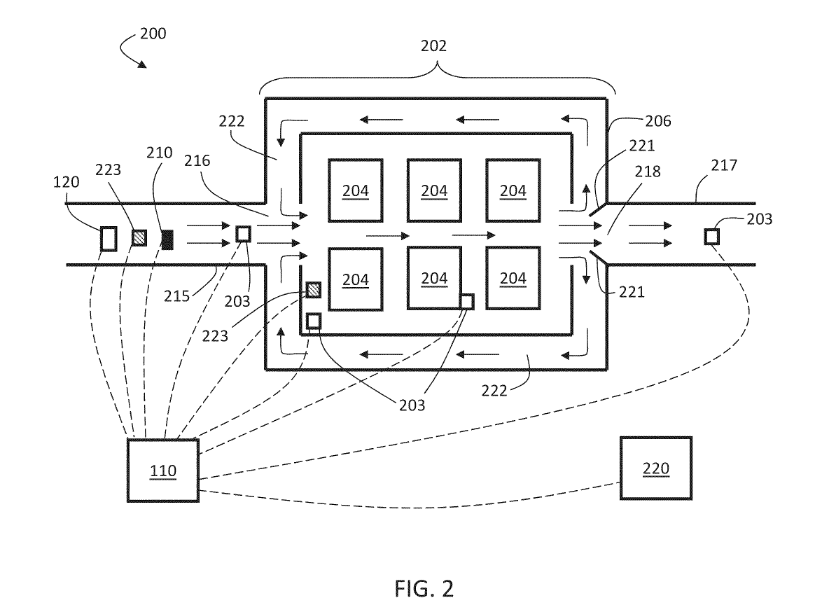

FIG. 2 is an exemplary schematic diagram illustrating temperature control system 200 to control the temperature of battery pack 202. In FIG. 2, battery pack 202 includes a plurality of electrochemically rechargeable battery cells 204 arranged within a container 206. While the battery pack of FIG. 2 is illustrated as including a plurality of battery cells, it should be understood that, other embodiments, the battery pack can include a single cell.

In FIG. 2, inlet passageway 215 connects the inlet 216 of battery pack 202 to a fluid (e.g., air) outside the battery pack. The battery pack can also include one or more outlets (e.g., outlet 218 feeding outlet passageway 217 in FIG. 2) through which fluid can be expelled from the battery pack. When one or more inlet(s) and outlet(s) of the battery pack are opened, as illustrated in FIG. 2, fluid from outside the battery pack can be transported through the battery pack to control the temperature within at least a region of the battery pack (i.e., the fluid can be a temperature control fluid).

In some embodiments, the fluid outside the battery pack can be at a substantially different temperature than a region within the battery pack, and can therefore be used to heat or cool the battery pack without pre-heating or pre-cooling. In such cases, the temperature set point of the cooling element can be set above the temperature of the incoming fluid such that no energy is unnecessarily expended to further cool the incoming fluid.

The cooling system can also include cooling element 120, which is configured to alter a temperature of battery pack 202 (e.g., by cooling a fluid that is fluidically and/or thermally connected to battery pack 202). In addition, temperature control system 200 includes heating element 210 configured to alter the temperature of battery pack 202 (e.g., by heating a fluid that is fluidically and/or thermally connected to battery pack 202). In some instances, the fluid outside the battery pack is not sufficiently cold and/or hot to be used to control the temperature of the battery pack. In cases where the temperature control fluid is too hot to be used to effectively cool the battery pack, the temperature control fluid can be cooled by cooling element 120 (e.g., an evaporator through which evaporated refrigerant is transported) prior to entering battery pack 202, and subsequently used to cool battery cells 204. In embodiments in which the temperature control fluid is too cool to be used to effectively heat the battery pack, the fluid outside the battery pack can be heated by heating element 210 (e.g., a resistive heater, etc.) prior to entering battery pack 202, and subsequently used to heat battery cells 204.

The fluid from outside the battery pack can originate from any suitable source. For example, in some embodiments, the fluid may comprise air transported directly to the battery pack from outside the vehicle via an air intake system. In some cases, the fluid may be transported to the battery pack from another source within the vehicle pack (e.g., from a climate control system within the vehicle, from a compressed air cylinder, etc.).

In some embodiments, the battery pack can be configured such that temperature control fluid can be recirculated within the battery pack. Recirculation of fluid within the battery pack can be beneficial because it can obviate the need to dehumidify and/or alter the temperature of air from outside the battery pack. This can lead to significant energy savings. In some embodiments, the battery pack can include a passageway constructed and arranged to provide a flow path for recirculated temperature control fluid within the battery pack. For example, in FIG. 2, battery pack 202 includes recirculation passageway 222 which can be used to recirculated temperature control fluid within the battery pack. In some cases, the passageway may not include any discrete internal channels, and may comprise a self-sustaining flow path within the battery pack. For example, the passageway may comprise a laminar flow stream of fluid within the battery pack. One of ordinary skill in the art would be able to distinguish the difference between a self-sustaining flow path and incidental recirculation (e.g., via the formation of eddies) that may occur within a small portion of the battery pack. Any suitable device can be used to establish the pressure drop required to transport the recirculated fluid (e.g., a pump, fan, etc.). In some instances, fluid can be recirculated within the battery pack while fresh fluid is supplied from outside the battery pack, as illustrated in FIG. 2. In other cases, fluid can be recirculated within the battery pack while substantially no fluid is supplied from outside the battery pack (e.g., by closing inlet 216 and outlet 218 such that the battery pack is substantially sealed, thus prohibiting the flow of outside fluid into the battery pack).

The ratio of fresh fluid to battery-pack recirculated components of the fluid within the battery pack can be controlled using any suitable method. For example, the flow rate of a fluid transported into the battery pack can be controlled by varying a cross-sectional size of an inlet (e.g., via the actuation of baffles or fins at the inlet). The cross-sectional size of the inlet can be reduced when lower flow rates are desired, and can be increased with higher flow rates are desired. In some cases, the amount of fluid transported into the battery pack can be altered by controlling the device used to transport the fresh fluid to the battery pack (e.g., a fan or a pump). The flow rate of recirculated fluid can be controlled using similar methods (e.g., varying a cross-sectional size of a recirculation passageway, controlling the device (e.g., pump) used to transport the recirculated fluid within the battery pack, etc.). In some embodiments, the ratio of fresh fluid to battery-pack recirculated components of the fluid within the battery pack can be controlled by adjusting the positions of one or more fins at the fluid outlet. For example, temperature control system 200 in FIG. 2 includes fins 221 positioned near the outlet of the battery pack. When the fins are extended into the volume of the battery pack (as shown in FIG. 2), a portion of the fluid that would otherwise exit the pack is directed into the recirculation pathway, as indicated by the curved arrows proximate fins 221 in FIG. 2. One of ordinary skill in the art would be capable of identifying other suitable methods of changing the ratio of fresh fluid and recirculated fluid for a given system.

In some embodiments, the system can include one or more temperature sensors used to measure at least one temperature within the system and/or to determine a temperature indicative of a region outside the system. Temperature sensors can be located within any suitable region of the system. In some cases, a temperature sensor can be located within the battery pack. For example, a temperature sensor can be located on the surface of a cell within the pack or on another surface of the battery pack container (e.g., proximate a cell within the pack). A temperature sensor can be located, in some cases, within a recirculation pathway within a battery pack. In some cases, a temperature sensor can be located within the inlet passageway that connects the battery pack to the fluid outside the battery pack, and can be used to determine a temperature indicative of a fluid outside the battery pack. A temperature sensor can also be located, in some cases, in an outlet passageway downstream of the battery pack. One of ordinary skill in the art would be capable of positioning a temperature sensor in an appropriate location to achieve a desired temperature determination. In the set of embodiments illustrated in FIG. 2, temperature sensors 203 are positioned within inlet passageway 215, battery pack 202, and outlet passageway 217

In some cases, multiple temperature sensors can be used to provide temperature data in multiple locations within the system. Such embodiments can be useful, for example, in determining the extent of any temperature gradients within the battery pack, the presence of which might inhibit battery pack performance. In particular, the use of multiple temperature sensors can be useful in determining the location and/or temperature of particularly hot and/or cold regions within the battery pack.

Temperature control system 200 can also include controller 110, which can be constructed and arranged to alter the temperature set point of cooling element 120 in response, at least in part, to an operating condition of the vehicle. In some embodiments, controller 110 can be constructed and arranged to receive a signal from a component of the vehicle. For example, in some embodiments in which controller 110 is configured to alter the temperature set point of cooling element 120 based on an acceleration, deceleration, and/or speed, controller 110 can be configured to receive a signal from a sensor that can be used to calculate the acceleration, deceleration, and/or speed.

In some embodiments, controller 110 can be configured to receive a signal from a temperature sensor (e.g., from a temperature sensor within the battery pack and/or outside the battery pack), and based upon the temperature sensor signal, can adjust the temperature set point of cooling element 120. For example, in FIG. 2, controller 110 is configured to receive a signal from temperature sensors 203.

In some instances, controller 110 can be configured to receive a signal from a flow rate sensor and/or flow controller within the battery pack and, based upon the signal, adjust the temperature set point of cooling element 120. For example, in FIG. 2, flow rate sensors 223 can be configured to transmit a signal to controller 110 indicative of the flow rate of the temperature control fluid. Controller 110 can then calculate the ratio of fresh fluid to battery-pack recirculated components of the fluid within the battery pack and, if necessary, adjust the temperature set point of cooling element 120.

The temperature of the cooling element can be controlled (e.g., in response to a signal corresponding to the set point determined by a control unit) using methods known to those of ordinary skill in the art. When an evaporator is used as the cooling element, the temperature of the evaporator can be controlled by controlling the pressure of the refrigerant going into the evaporator, as controlled by varying the speed of and/or power supplied to the AC compressor. For example, when lower evaporator temperatures are desired, the pressure of the refrigerant exiting the AC compressor can be increased, and when higher evaporator temperatures are desired, the pressure of the refrigerant exiting the AC compressor can be decreased. Pressure going to the evaporator system can be controlled, for example, by varying the speed of the compressor (e.g., increasing the speed to increase pressure and/or decreasing the speed to decrease pressure), manipulating one or more expansion valves (e.g., in a suction throttling system), and/or via any other suitable method.

While the embodiments illustrated in FIG. 2 include a controller 110 with internal logic capable of processing signals from other components of the temperature control system and/or vehicle, it should be understood that in other cases, a separate logic unit (e.g., optional logic unit 220 in FIG. 2, a powertrain control module (PCM)) may be used to receive signals from various vehicle components, perform one or more calculations based upon those signals, and/or transmit a signal based upon the signals received from other system components to controller 110. For example, calculation of the acceleration of the vehicle, deceleration of the vehicle, speed of the vehicle, regenerative braking level, the fresh/recirculated fluid ratio, and/or state of charge of the battery pack can be performed within controller 110 and/or within another component of the vehicle, such as optional logic unit 220 and/or a PCM. In addition, determination of and/or storage of a characteristic of a driver profile can be performed within controller 110 and/or within another component of the vehicle, such as optional logic unit 220 and/or a PCM. As a specific example, in some embodiments, flow rate sensors 223 can be configured to transmit a signal to logic unit 220 (and/or a PCM), which can then calculate the ratio of fresh fluid to battery-pack recirculated components of the fluid within the battery pack. Logic unit 220 (and/or a PCM) can then transmit a signal to controller 110 which can, if necessary, adjust the temperature set point of cooling element 120. In some embodiments, controller 110 can be part of a PCM.

In the embodiment illustrated in FIG. 2, the transmission of information is generally illustrated via dotted lines. The transmission of information among components of the battery pack or other components of the system to and/or from the control system(s) can be achieved by any suitable method. For example, in some cases, information can be transmitted along wired connections. In some embodiments, the information can be transmitted wirelessly.

In addition, while FIG. 2 illustrates one set of embodiments in which a single controller is used, in other embodiments, multiple controllers can be employed. For example, in some embodiments, the system can include two, three, four, or more controllers.

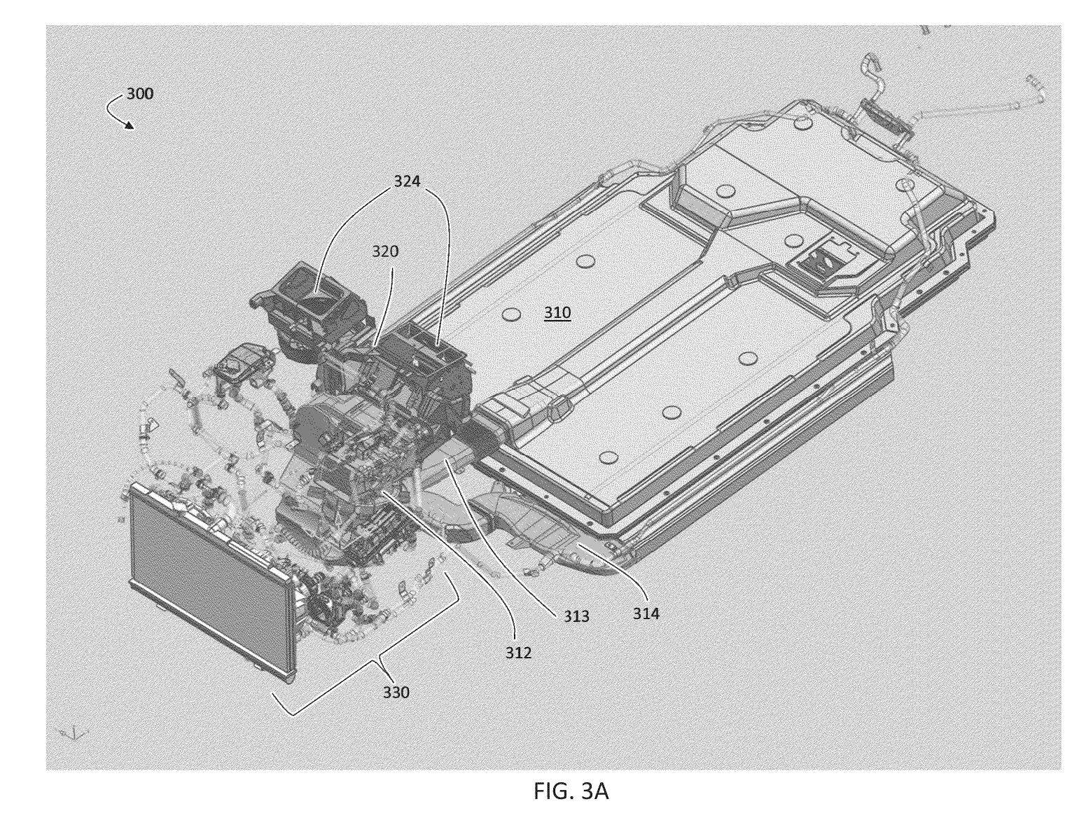

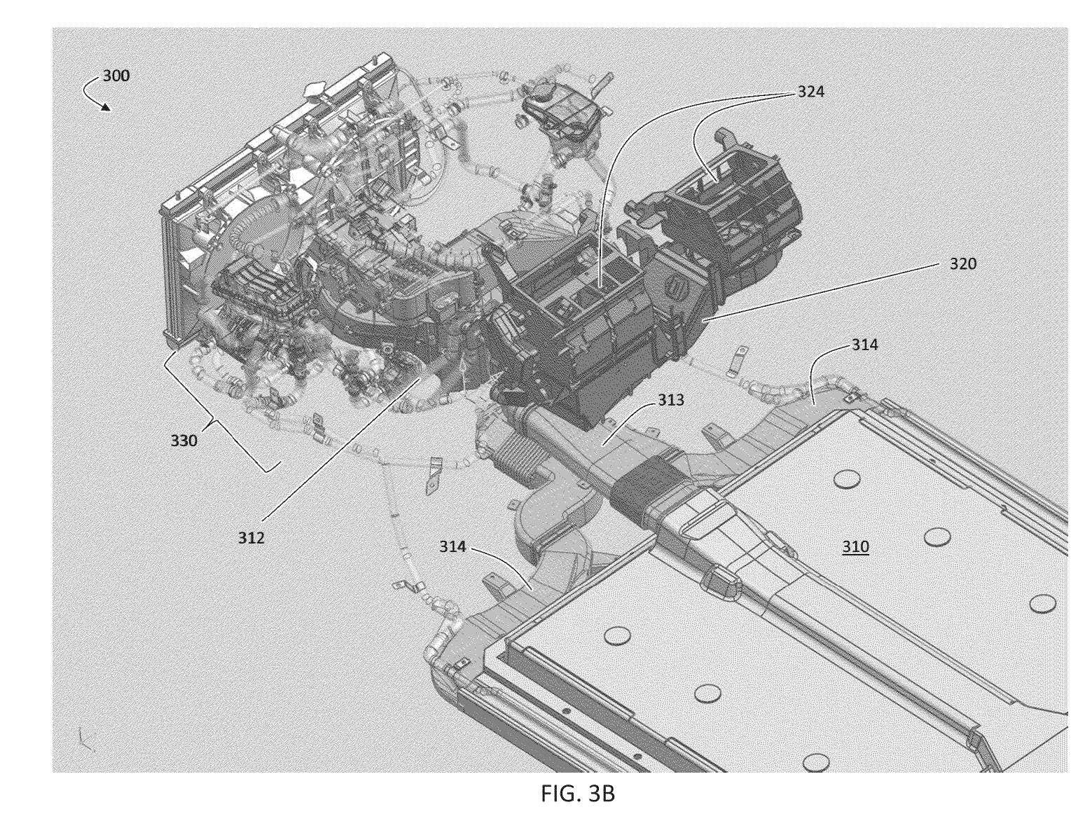

In some embodiments, the vehicle in which the battery pack is used can include independent cabin and battery air cooling and/or heating loops. FIGS. 3A-3B include schematic illustrations of one such set of embodiments. In FIGS. 3A-3B, system 300 includes a battery pack 310 mounted outside and under the cabin of a vehicle. Battery pack 310 has its own independent heating/cooling conduit loop for transporting temperature control fluid to and from the battery pack. The battery pack conduit loop includes a battery pack HVAC box 312 including an evaporator, heat exchanger, and blower located under the hood of the vehicle. Battery pack inlet duct 313 is constructed and arranged to transport temperature control fluid from battery pack HVAC box 312 to battery pack 310, and battery pack return ducts 314 are constructed and arranged to transport temperature control fluid from battery pack 310 to battery pack HVAC box 312.

In addition, in FIGS. 3A-3B, the cabin has its own independent heating/cooling conduit loop for transporting temperature control fluid to and from the cabin. The cabin heating/cooling conduit loop includes a cabin HVAC box 320. The cabin HVAC box 320 can be located within the cabin, as is standard in passenger vehicles. The cabin heating/cooling loop can include a cabin inlet duct constructed and arranged to transport temperature control fluid from the cabin HVAC box 320 to the cabin and one or more cabin return ducts 324 constructed and arranged to transport temperature control fluid from the cabin to cabin HVAC box 320.

In some embodiments, the cabin and battery pack heating/cooling conduit loops share a central condenser, compressor, and/or heating element. These components can be shared, for example, by fluidically connecting the heating/cooling conduit loops using three-way valves. In FIGS. 3A-3B, for example, region 330 includes a central condenser and compressor for processing a shared refrigerant. In addition, region 330 includes a shared heating element for heating the temperature control fluid.

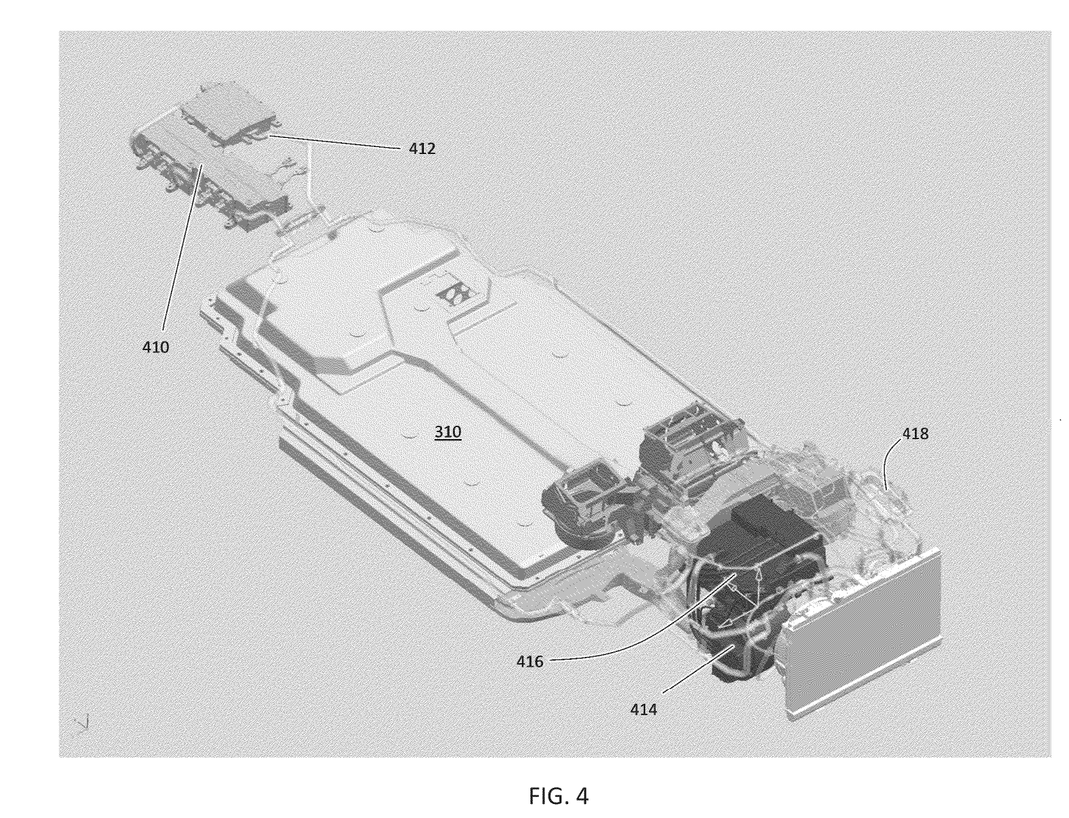

In some embodiments, the vehicle includes a heat integration system constructed and arranged to use heat generated by various vehicle components to heat a temperature control fluid within a heating loop. For example, in the set of embodiments illustrated in FIG. 4, waste heat form the vehicle's powertrain components may be harnessed via a temperature control fluid within the heating loop. In FIG. 4, heat is harnessed from charger 410, DC/DC converter 412, motor 414, and/or inverter 416. The harnessed heat can be used to supplement the heat generated by the heating element (e.g., a positive temperature coefficient (PTC) heater 418 in FIG. 4) in order to improve vehicle efficiency. The introduction of this waste heat to the HVAC systems may be controlled via valves controlled by the system thermal controller.

The control system(s) used in the various embodiments described herein can be of any suitable type. In some embodiments, the control system can include a microprocessor constructed and arranged to perform one or more calculations the result of which may be used to change a property of the system. In some cases, the control system may include memory. Various embodiments according to the invention may be implemented on one or more computer systems. For example, the control systems described herein can include a computer system, in some embodiments. These computer systems, may be, for example, general-purpose computers such as those manufactured by Intel, Advanced Micro Devices (AMD), Motorola, IBM, Sun, Hewlett-Packard, and/or any other type of processor. It should be appreciated that one or more of any type of computer system may be used to implement various embodiments of the invention. The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A variety of sensors (optionally in combination with one or more logic units) can be employed to determine various conditions related to an operating state of the vehicle. Temperature can be measured using any suitable temperature sensor such as, for example, a thermocouple, a thermistor, a thermometer, positive temperature coefficient (PTC) sensor, and/or any other suitable type of temperature sensor. Speed can be determined using any suitable method such as via a wheel speed sensor, a driveline speed sensor, a GPS-based speed calculation, and the like. Vehicle acceleration and deceleration can be determined, for example, by calculating the rate of change in the vehicle speed and/or by employing a sensor such as, for example, an accelerometer and the like. Regenerative braking levels can be determined, for example, using pedal position, regenerative current sensing, brake line pressure sensing, and the like. The state of charge and/or rate of change of the state of charge of the battery pack can be determined using, for example, the battery management system. The flow rate of one or more temperature control fluids (which can be used to calculate the recirculation ratio) can be determined, for example, using any suitable flow sensor, may be inferred from the power supplied to the pump or blower, or may be inferred from the difference in temperature across the evaporator.

The systems and methods described herein can be used in any suitable vehicle in which a battery pack is employed. In some embodiments, the systems and methods can be used to control the flow of fluid within a battery pack system used in an automobile (e.g., a battery pack used to power the drive train of an electric or hybrid automobile). In embodiments where the battery pack is used in an automobile, the battery pack can be positioned in any suitable location (e.g., under the floor board, in the trunk, under the front hood, etc.). Fresh fluid supplied to the battery pack can originate from any suitable location. For example, fresh fluid may originate from an air intake, the flow of which can be driven by the natural motion of the automobile and/or by a pump or other suitable device.

The battery pack can be formed in any suitable shape (e.g., a rectangular prism, cylinder, sphere, etc.). In addition, the systems and methods described herein can be used with battery packs of any suitable size.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system for controlling temperature within a battery pack of a vehicle, comprising:
a battery pack; and
a control unit constructed and arranged to alter a temperature set point of a cooling element configured to alter a temperature of the battery pack,
wherein the alteration of the temperature set point of the cooling element is based at least in part upon a condition related to an operating state of the vehicle.

2. The system of claim 1, wherein the control unit is constructed and arranged to dynamically alter a temperature set point of a cooling element based at least in part upon a condition related to an operating state of the vehicle.

3. The system of claim 1, wherein the cooling element comprises an evaporator.

4. The system of claim 1, wherein the control unit is constructed and arranged to receive a signal indicative of an operating state of the vehicle.

5. The system of claim 1, wherein the operating state of the vehicle comprises an acceleration level and/or deceleration level of the vehicle.

6. The system of claim 5, wherein the operating state of the vehicle comprises a substantially instantaneous acceleration level and/or deceleration level of the vehicle.

7. The system of claim 5, wherein the operating state of the vehicle comprises an average acceleration level and/or deceleration level of the vehicle.

8. The system of claim 1, wherein the operating state of the vehicle comprises a speed of the vehicle.

9. The system of claim 8, wherein the operating state of the vehicle comprises a substantially instantaneous speed of the vehicle.

10. The system of claim 8, wherein the operating state of the vehicle comprises an average speed of the vehicle.

11. The system of claim 1, wherein the operating state of the vehicle comprises a temperature.

12. The system of claim 11, wherein the temperature comprises a temperature within the battery pack.

13. The system of claim 11, wherein the temperature comprises a temperature outside the battery pack.

14. The system of claim 13, wherein the temperature outside the battery pack comprises a temperature indicative of the ambient air temperature outside the vehicle.

15. The system of claim 11, wherein the operating state of the vehicle comprises a plurality of temperatures.

16. The system of claim 1, wherein the operating state of the vehicle comprises a regenerative braking level.

17. The system of claim 1, wherein the operating state of the vehicle comprises a state of charge of the battery pack.

18. The system of claim 1, wherein the operating state of the vehicle comprises a rate of change of the state of charge of the battery pack.

19. The system of claim 1, wherein the operating state of the vehicle comprises a characteristic of a programmable driver profile.

20. The system of claim 1, wherein the operating state of the vehicle comprises a ratio of a flow rate of a fresh temperature control fluid to a flow rate of a battery-pack recirculated component of a temperature control fluid within the battery pack.

21. The system of claim 20, wherein the temperature control fluid comprises air.

22. The system of claim 1, wherein the operating state of the vehicle comprises information from a navigation and telematics system of the vehicle.

23. The system of claim 1, wherein the vehicle comprises an automobile.

24. The system of claim 1, wherein the battery pack is used to power the drive train of the vehicle.

25. A method of controlling temperature within a battery pack of a vehicle, comprising:
determining a condition related to an operating state of the vehicle;
based at least in part upon the determination, altering a temperature set point of a cooling element configured to alter a temperature of the battery pack; and
altering a temperature of the battery pack in response to the alteration of the temperature set point.

26. A method as in claim 25, wherein determining a condition related to an operating state of the vehicle comprises transmitting a signal to a controller.

27. A method as in claim 25, wherein altering a temperature of the battery pack comprises transporting a temperature control fluid through a region proximate the cooling element to cool the temperature control fluid.

28. A method as in claim 27, wherein the temperature control fluid comprises air.

29. A method as in claim 25, wherein the cooling element comprises an evaporator.
